(19) United States
(12) Patent Application Publication
(10) Pub. No.: US 2019/0352585 A1
(43) Pub. Date: Nov. 21, 2019

(54) Processes and Compositions for Treating Facilities

(71) Applicant: Dooley Chemicals, LLC, Chattanooga, TN (US)

(72) Inventors: Kevin Hrebenar, Chattanooga, TN (US); David Halstead, Chattanooga, TN (US); Eric Spell, Chattanooga, TN (US)

(21) Appl. No.: 16/413,263

(22) Filed: May 15, 2019

Related U.S. Application Data
(60) Provisional application No. 62/672,221, filed on May 16, 2018.

(51) Int. Cl. C11D 11/00; C11D 1/00; C11D 3/00; C11D 3/16; C11D 3/12; C11D 3/37; B08B 17/02

(52) U.S. Cl. CPC C11D 11/0041; C11D 1/004; C11D 1/008; B08B 17/02; C11D 3/162; C11D 3/1206; C11D 3/3753; C11D 3/0036

(57) ABSTRACT

An improved composition and method of use is provided which is suitable for treating live animal growth facility, meat processing facilities and food processing facilities. The composition comprises 34-99.35 wt % water; 0.1 to 3 wt % hydrophobizing agents; up to 5 wt % antistatic agents; 0.05 to 3 wt % wetting agents; and 0.5 to 55 wt % film forming agent. The composition is applied to surfaces and allowed to dry.

### CROSS-REFERENCE TO RELATED APPLICATIONS

The present invention claims priority to pending U.S. Provisional Application No. 62/672,221 filed May 16, 2018 which is incorporated herein by reference.

### FIELD OF THE INVENTION

The present invention is related to an improved composition for treating facilities and methods for treating facilities which are preferably selected from live animal growth facilities, meat processing facilities and food processing facilities. More specifically, the present invention is related to an improved composition for treating live animal growth facilities, meat processing facilities and food processing facilities, and methods for treating a live animal growth facilities, meat processing facilities and food processing facilities wherein surfaces of the facility, surrounds and components thereof are treated to be less susceptible to build up of residue and any residue that does accumulate is more easily removed.

### BACKGROUND

There is mounting pressure globally to reduce the use of antibiotics in managing animal production. This has led to a desire to utilize alternative practices and products in lieu of antibiotics to manage animal health. One limiting factor is the propensity for build-up of residue on metal surfaces within live animal growth facilities, meat processing facilities and food processing facilities. The residue is susceptible to harboring bacteria and other elements which can be harmful to animals or can contaminate food products prepared or stored. Reducing soil build-up and improving cleaning effectiveness and efficiency in all phases of animal production and food production is labor intensive and difficult work which has led to the extensive use of antibiotics.

Provided herein is an improved formulation for cleaning surfaces of facilities such as live animal growth facilities, meat processing facilities and food processing facilities which is not harmful to the animals and which is effective at maintaining a clean surface.

### SUMMARY OF THE INVENTION

The invention is related to an improved composition for treatment of live animal growth facilities, meat processing facilities and food processing facilities wherein residue build up on surfaces is minimized.

A particular feature of the invention is that any residue on treated surfaces is less tenacious and easier to remove.

These and other embodiments, as will be realized, are provided in a composition for treating facilities such as live animal growth facilities, meat processing facilities and food processing facilities. The composition comprises:
34-99.35 wt % water;
0.1 to 3 wt % hydrophobizing agents;
up to 5 wt % antistatic agents;
0.05 to 3 wt % wetting agents; and
0.5 to 55 wt % film forming agent.

Yet another embodiment is provided in a method for treating facilities such as live animal growth facilities, meat processing facilities and food processing facilities.
The method comprises:
applying a composition to at least one surface of the facility wherein the composition comprises:
34-99.35 wt % water;
0.1 to 3 wt % hydrophobizing agents;
up to 5 wt % antistatic agents;
0.05 to 3 wt % wetting agents; and
0.5 to 55 wt % film forming agent; and
allowing the composition to dry thereby forming a coating on the surface.

### DESCRIPTION

The present invention is related to an improved composition for treatment of facilities and an improved method for treating facilities and particularly live animal growth facilities, meat processing facilities and food processing facilities.

By reducing soil build-up during the growth phase of animals in an live animal growth facilities, meat processing facilities and food processing facilities the matrix that can harbor and promote growth of unhealthy microbes, bacteria and viruses is significantly reduced and preferable eliminated. The present invention provides a much cleaner environment initially and reduces the amount of disinfectants required for proper and complete sanitation of the surfaces of the facility, surrounds and components thereof. Improving the cleaning efficiency also reduces the amount of time required for cleaning and significantly reduces the amount of water required for cleaning. Reduced water usage improves operating costs, due to the direct cost of the fresh water, as well as reducing the load on water treatment facilities and waste holding ponds.

The invention provides for compositions that are applied to all hard surfaces in the live animal growth facilities, meat processing facilities and food processing facilities, surrounds and components thereof where dust, manure and other unwanted soils may attach and build-up during the grow out. These surfaces include but are not limited to exhaust fans, louvres and hoods, water lines, air inlet vents, feed lines, live animal farrowing crates, live animal nursery walls, floors in general, milking facilities, feed mills, feeding facilities, livestock transportation trailers and livestock transportation cages.

The composition, once applied, chemically modifies the surface properties so that any unwanted soils that comes into contact with the treated surfaces are less adherent and easier to remove during any subsequent washings.

The composition comprises surfactants and other surface modifying materials that will render the surface much less suitable for any unwanted soils to adhere to the treated surfaces thereby making the surfaces easier clean. These compositions include hydrophobizing agents, optional antistatic agents, wetting agents and/or film forming agents. Other components may be included in the formulations to provide other desirable characteristics. These components include: disinfecting agents, antimicrobial agents, antibacterial agents, antiviral agents, fragrances, hydrophilizing agent, clarifyiers, etc.

The composition comprises 34-99.35 wt % water; 0.1 to 3 wt % hydrophobizing agents and more preferably 0.1 to 0.3 wt % hydrophobizing agents; up to 5 wt % antistatic agent and preferably up to 3 wt % antistatic agent; 0.05 to 3 wt % wetting agents, preferably 0.1 to 2 wt % wetting agents, more preferably 0.1 to 1 wt % wetting agents and even more preferably 0.1 to 0.5 wt % wetting agents; 0.5 to 55 wt % film forming agent, more preferably 1 to 55 wt % film forming agent, even more preferably 3.5 to 55 wt % film forming agent, even more preferably 3.5 to 15 wt % film forming agent, even more preferably 3.5 to 10 wt % film forming agent and most preferably 3.5 to 8 wt % film forming agent with other components present in up to 1 wt %, more preferably 0.1 to 1 wt % and most preferably 0.1 to 0.5 wt %.

The composition provides a hydrophobic surface. The hydrophobic surface makes it difficult for unwanted soils, and especially moisture containing soils, to adhere to the treated surfaces. In this regard, the unwanted soils may not attach at all or may be removed by natural forces such as wind or air flow, gravity, or the scrubbing actions of animals moving against the treated surface. These types of conditions and soils are particularly found in live animal growth facilities where fecal matter or manure may be the primary contaminant. Similar issues arise in other facilities such as meat processing facilities and food processing facilities Furthermore, these surfaces will be much easier to clean since the soils do not adhere as strongly to the treated surfaces. Finally, properly hydrophobized surfaces inhibit the growth of unwanted microbes, bacteria and viral agents since the surface is more difficult for them to adhere to which is a requirement for their proliferation. Particularly preferred hydrophobizing agents include but are not limited to: fluorochemicals, fluorosilicones, silicones, silanes, long chain hydrocarbons, oils and resins. Hydrocarbon modified silane quaternary ammonium compounds are preferred with Flexipel Q-50 being particularly preferred.

In one embodiment the composition provides an antistatic effect to the surface by providing an antistatic modified surface. The antistatic modified surface makes it particularly difficult for dry soils to adhere to surfaces due to electrostatic charges that may develop during the normal course of action. For example, electrostatic charges may develop on exhaust fan components in poultry houses due the rapid movement of relatively dry air across nonconductive surfaces. These highly charged surfaces are particularly attractive to dusts and other particulate material found in live animal growth poultry facilities, meat processing facilities and food processing facilities. Non-conductive surfaces found on fan components may comprise plastic composites or fiberglass as nonlimiting examples. These treated surfaces are much easier to clean after treatment with the composition since the soils are less adherent to the treated surfaces.

Antistatic agents include but are not limited to: cationic surfactants, anionic surfactants, nonionic surfactants, metallic particles, electro conducting particles and hygroscopic materials.

A particular feature of the composition is the inclusion of a wetting agent. A wetting agent insures that all surfaces are completely wetted out and covered by the composition. Wetting agents also insure good penetration and wetting of any micropores that may be present on some surfaces such as galvanized metals and components that have been surface eroded by the strong, surface degrading cleaning chemicals that are currently required to clean contaminated surfaces.

Wetting agents include but are not limited to: fluoro surfactants, silicone surfactants, trisiloxanes, and hydrocarbon surfactants. Particularly preferred are low viscosity nonionic ethoxylated trisiloxanes with HSil STS being particularly preferred or nonionic ethoxylated fluorosurfactants with Thetawet FS-8050 being particularly preferred.

Another particular feature of the composition is the inclusion of a water-soluble, film-forming agent. These agents serve at least two purposes. They provide for a strongly adhering film that will more strongly hold the other desired components on the treated surfaces and make them less susceptible to wearing away by the mechanical forces that may be present in the facilities such as rubbing by moving animals. Also, by selecting the correct film-forming agent provides for a surface that is much more suitable for effective and efficient cleaning with simple water sprays. By providing a film that is water soluble, or slightly water soluble, any soil that may be adhered to the surface will be more easily washed away since the surface to which they are attached will dissolve into the water and be easily washed away by using only a water spray. The film formed may function as a sacrificial film which delaminates, at least, partially during use.

Film forming agents include but are not limited to: polyvinyl alcohols across all molecular weights and degrees of hydrolysis, polyvinyl acetates, polyacrylates, fluorinated polymers, silicone polymers, any potentially water-soluble film-forming polymer. Fully hydrolyzed polyvinyl alcohols are a particularly preferred film forming agent. Elvanol 71-30 is a particularly preferred film forming agents.

The composition is applied to surfaces to be treated by any liquid application technique including spraying, brushing, rolling or dipping. It is preferred that the composition be allowed to dry before exposure to residue with air drying being preferred due to cost considerations. Drying can be accelerated by flowing air and particularly warmed flowing air.

In an exemplary embodiment an aqueous composition would be prepared. The aqueous composition would comprise at least one film forming agent selected from Elvanol 71-30 in the appropriate amount. Thetawet FS-8050 or HSil STS would be added as a wetting agent in the appropriate amount. Flexipel Q-50 would be utilized as an effective hydrophobic material in the appropriate amount. The composition would be applied to any surface to be treated as a liquid and then be allowed to dry thereby forming a treated surface comprising a film. The treated surface would be less susceptible to build up of soils and related materials and any material which did accumulate would be easily removed by natural conditions such as wind or animal contact or easily removed by spraying with water.

The invention has been described with reference to the preferred embodiments without limit thereto. One of skill in the art would realize additional embodiments and improvements which are not specifically stated but which are within the meets and bounds of the claims appended hereto.

Claimed is:

1. A composition for treating facilities comprising:
34-99.35 wt % water;
0.1 to 3 wt % hydrophobizing agents;
up to 5 wt % antistatic agents;
0.05 to 3 wt % wetting agents; and
0.5 to 55 wt % film forming agent.

2. The composition of claim 1 wherein said facility is selected from a live animal growth facility, a meat processing facility and a food processing facility.

3. The composition of claim 1 comprising 0.1 to 0.3 wt % hydrophobizing agents.

4. The composition of claim 1 wherein said hydrophobizing agents are selected from fluorochemicals, fluorosilicones, silicones, silanes, long chain hydrocarbons, oils and resins.

5. The composition of claim 1 wherein said hydrophobizing agents comprise hydrocarbon modified silane quaternary ammonium.

6. The composition of claim 1 comprising up to 3 wt % antistatic agent.

7. The composition of claim 1 wherein said antistatic agents are selected from the group consisting of cationic surfactants, anionic surfactants, nonionic surfactants, metallic particles and electro conducting particles.

8. The composition of claim 1 comprising 0.1 to 2 wt % wetting agents.

9. The composition of claim 8 comprising 0.1 to 1 wt % wetting agents.

10. The composition of claim 9 comprising 0.1 to 0.5 wt % wetting agents.

11. The composition of claim 1 wherein said wetting agents are selected from the group consisting of fluoro surfactants, silicone surfactants, trisiloxanes, hydrocarbon surfactants and film forming agents.

12. The composition of claim 1 comprising 1 to 55 wt % film forming agent.

13. The composition of claim 12 comprising 3.5 to 55 wt % film forming agent.

14. The composition of claim 13 comprising 3.5 to 15 wt % film forming agent.

15. The composition of claim 14 comprising 3.5 to 10 wt % film forming agent.

16. The composition of claim 15 comprising 3.5 to 8 wt % film forming agent.

17. The composition of claim 1 wherein said film forming agents are selected from the group consisting of polyvinyl alcohols, polyvinyl acetates, polyacrylates, fluorinated polymers and silicone polymers.

18. The composition of claim 17 wherein said film forming agents are fully hydrolyzed polyvinyl alcohols.

19. A method for treating a facility comprising:
applying a composition to at least one surface of said facility wherein said composition comprises:
34-99.35 wt % water;
0.1 to 3 wt % hydrophobizing agents;
up to 5 wt % antistatic agents;
0.05 to 3 wt % wetting agents; and
0.5 to 55 wt % film forming agent;
allowing said composition to dry thereby forming a coating on said surface.

20. The method for treating a facility of claim 19 wherein the facility is selected from a live animal growth facility, a meat processing facility and a food processing facility.

21. The method for treating a facility of claim 19 wherein said surface is selected from the group consisting of exhaust fans, louvres, hoods, water lines, air inlet vents, feed lines, live animal farrowing crates, live animal nursery walls, floors, milking facilities, feed mills, feeding facilities, livestock transportation trailers and livestock transportation cages.

22. The method for treating a facility of claim 19 wherein said applying is selected from the group consisting of spraying, brushing, rolling and dipping.

23. The method for treating a facility of claim 19 wherein said drying is selected from air drying and accelerated drying.

24. The method for treating a facility of claim 23 wherein said accelerated drying comprises drying with flowing air.

25. The method for treating a facility of claim 24 wherein said accelerated drying comprises drying with warmed flowing air.

26. The method for treating a facility of claim 19 comprising 0.1 to 0.3 wt % hydrophobizing agents.

27. The method for treating a facility of claim 19 wherein said hydrophobizing agents are selected from fluorochemicals, fluorosilicones, silicones, silanes, long chain hydrocarbons, oils and resins.

28. The method for treating a facility of claim 19 wherein said hydrophobizing agents comprise hydrocarbon modified silane quaternary ammonium.

29. The method for treating a facility of claim 19 comprising up to 3 wt % antistatic agent.

30. The method for treating a facility of claim 19 wherein said antistatic agents are selected from the group consisting of cationic surfactants, anionic surfactants, nonionic surfactants, metallic particles and electro conducting particles.

31. The method for treating a facility of claim 19 comprising 0.1 to 2 wt % wetting agents.

32. The method for treating a facility of claim 31 comprising 0.1 to 1 wt % wetting agents.

33. The method for treating a facility of claim 32 comprising 0.1 to 0.5 wt % wetting agents.

34. The method for treating a facility of claim 19 wherein said wetting agents are selected from the group consisting of fluoro surfactants, silicone surfactants, trisiloxanes, hydrocarbon surfactants and film forming agents.

35. The method for treating a facility of claim 19 comprising 1 to 55 wt % film forming agent.

36. The method for treating a facility of claim 35 comprising 3.5 to 55 wt % film forming agent.

37. The method for treating a facility of claim 36 comprising 3.5 to 15 wt % film forming agent.

38. The method for treating a facility of claim 37 comprising 3.5 to 10 wt % film forming agent.

39. The method for treating a facility of claim 38 comprising 3.5 to 8 wt % film forming agent.

40. The method for treating a facility of claim 20 wherein said film forming agents are selected from the group consisting of polyvinyl alcohols, polyvinyl acetates, polyacrylates, fluorinated polymers and silicone polymers.

41. The method for treating a facility of claim 40 wherein said film forming agents are fully hydrolyzed polyvinyl alcohols.
